(19) United States
(12) Patent Application Publication
(10) Pub. No.: US 2008/0151444 A1
(43) Pub. Date: Jun. 26, 2008

(54) METHOD AND APPARATUS FOR PROTECTION AGAINST CURRENT OVERLOADS

(76) Inventor: JOHN D UPTON, Georgetown, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/613,346

(22) Filed: Dec. 20, 2006

(51) Int. Cl. H02H 7/08; H02H 9/02; G08B 21/00

(52) U.S. Cl. 361/31; 361/93.1; 340/664

(57) ABSTRACT

An over-current protection device is provided that uses a micro-controller to sense and interrupt current flow used by motors. Because the same micro-controller that is operating the motors may be used for the overall application current monitoring, no significant hardware overhead is incurred. The micro-controller uses two input/output pins to perform the sensing and control.

### BACKGROUND

1. Technical Field

The present application relates generally to small direct-current-mode device control. More specifically, the present application is directed to protection of control circuits against over-current situations where the potential for circuit damage or fire exists.

2. Description of Related Art

Direct current servo motor and stepper motor controllers are often micro-controller based. Commercial uses of stepper and servo motors in document scanners and printers are very common. Robotics movement and light duty material handling are common industrial uses for the similar motor control systems. In many applications, it is advantageous to protect both the driver circuitry and the motors themselves against over-current conditions caused by stalled operation or short circuits. The most common forms of circuit over-current protection in the above-described applications are fuses, circuit breakers, and electronic resettable circuit interrupters, each having advantages and disadvantages.

Fuses have long been used for over-current protection. Fuses are quite inexpensive, can be either fast or slow acting, and have proven reliability. Fast acting, in the terminology for fuses, may be misleading. A fast-acting fuse may take tens or hundreds of milliseconds to operate at the rated opening current. The key disadvantages are that fuses are sometimes relatively large in size and must be physically replaced in a circuit after they have “blown” or performed their circuit protection function. Even though some fuses are available in compact physical packages suitable for printed circuit board mounting, they require reworking (repair) of the printed circuit board for replacement.

Circuit breakers also see very wide use in over-current protection applications. These devices work as a thermal crowbar switch and “blow” when a given amount of power has been detected. Higher over-currents result in faster detection and activation. Circuit breakers have the advantage of being made in similar sizes as some fuses, but the greatest advantage is that they are reusable any number of times. Circuit breakers can be reset for use again after performing their circuit protection function. Most circuit breakers may be reset with a manual push button, while others may be self-resetting after a “cool down” period. Because circuit breakers are electromechanical devices, they incur a minimum time delay of the order of tens of milliseconds for operation.

Resettable circuit interrupters, also referred to as resettable fuses, are similar to circuit breakers. Resettable circuit interrupters require no manual reset and are generally reset automatically whenever power is removed. The key difference between resettable circuit interrupters and circuit breakers is that circuit breakers are electromechanical devices, while interrupters are generally electrochemical. Because the operation of the device is thermal in nature, resettable circuit interrupters behave much like “slow blow” fuses in operation. In addition, while resettable circuit interrupters do reset after removal of load current, they do so following a cool down period. Momentary overloads, which activate the protection device, require a longer reset period than is sometimes desired for recovery.

### SUMMARY

The illustrative embodiments recognize the disadvantages of the prior art and provide an over-current protection device that uses a micro-controller to sense and interrupt current flow used by motors. Because the same micro-controller that is operating the motors may be used for the overall application current monitoring, no significant hardware overhead is incurred. The micro-controller uses two input/output pins to perform the sensing and control. A third pin may optionally be used for reporting circuit protection status.

In operation of the exemplary embodiment, current is sensed through the use of a low value series resistor. However, the actual conversion of the voltage across the sense resistor to an over-current sense alarm signal is performed using an optical isolator. In response to the over-current sense alarm signal, the micro-controller interrupts the primary power source using either a series relay or power field effect transistor.

In one illustrative embodiment, a method is provided for protecting against current overload. The method comprises receiving, by a device, current flow from a voltage source. The method further comprises responsive to detecting an over-current condition, setting an over-current detected flag. The method further comprises responsive to the over-current detected flag being set for a predetermined period of time, interrupting current flow to the device.

In one exemplary embodiment, the device comprises one of at least one motor or an external current control circuit coupled to a motor. In another exemplary embodiment, the device performs the setting step and the interrupting step, and wherein the setting step occurs substantially immediately after the device detects an over-current condition.

In a further exemplary embodiment, the method further comprises in response to setting the over-current detected flag, decrementing a counter. The counter fully decrements over the predetermined amount of time. The method further comprises while the counter is decrementing, selectively examining the over-current detected flag to determine whether the flag remains set.

In a still further exemplary embodiment, the method further comprises sensing a voltage drop across a sense resistor wherein an over-current condition exists when the voltage drop across the sense resistor exceeds a predetermined threshold. In yet another exemplary embodiment, sensing a voltage drop across a sense resistor comprises sensing whether an optical isolator that is connected in parallel with the sense resistor is in a closed state, wherein an over-current condition exists when the optical isolator is in a closed state.

In another exemplary embodiment, the interrupting step comprises opening a relay between the voltage source and the device. In a further exemplary embodiment, the method further comprises responsive to detecting a non over-current condition when the over-current detected flag is set, waiting a second predetermined amount of time, determining if the non over-current condition is present upon expiration of the second predetermined amount of time, and responsive to determining that the non over-current condition is present, resetting the over-current detected flag.

In a further exemplary embodiment, interrupting current flow to the device comprises providing a voltage to a source of a light emitting diode side of the optical isolator. A phototransistor side of the optical isolator is connected to a gate of the power field effect transistor and is connected to a source of the power field effect transistor through a transistor. The method further comprises providing a voltage to a drain of the light emitting diode side of the optical isolator such that the light emitting diode side of the optical isolator does not emit light so that current does not flow through the phototransistor side of the optical isolator.

In a still further exemplary embodiment, the method further comprises responsive to detecting an over-current condition, activating a warning light emitting diode. In yet another exemplary embodiment, the method further comprises responsive to an absence of the over-current condition for a recovery period, resetting the over-current detected flag.

In another illustrative embodiment, a device comprises at least one motor, a series sense resistor and a current interrupt component in series between an input voltage and the at least one motor, and a microcontroller. The microcontroller, responsive to detecting an over-current condition at the series sense resistor, sets an over-current detected flag, and responsive to the over-current detected flag being set for a predetermined period of time, interrupts current flow to the device using the current interrupt component.

In one exemplary embodiment, the micro-controller controls the at least one motor, and the micro-controller performs the detecting, setting, and interrupting steps responsive to an interrupt timer.

In a further illustrative embodiment, a current overload protection apparatus comprises a series sense resistor and a current interrupt component in series between an input voltage and a device and a microcontroller. The microcontroller, responsive to detecting an over-current condition at the series sense resistor, sets an over-current detected flag and responsive to the over-current detected flag being set for a predetermined period of time, interrupts current flow to the device using the current interrupt component.

In one exemplary embodiment, the device comprises at least one motor. In another exemplary embodiment, the current overload protection apparatus further comprises an optical isolator connected in parallel with the sense resistor. The microcontroller senses whether the optical isolator is in a closed state. An over-current condition exists when the optical isolator is in a closed state.

In a further exemplary embodiment, the current interrupt component is a relay. The microcontroller interrupts current to the device by opening the relay.

In another exemplary embodiment, the current interrupt component is a power field effect transistor. The current overload protection apparatus further comprises an optical isolator connected to the power field effect transistor. The microcontroller interrupts current to the device by opening the optical isolator such that the power field effect transistor changes to an open state.

In another illustrative embodiment, a computer program product comprises a computer useable medium having a computer readable program. The computer readable program, when executed on a microcontroller in a current overload protection apparatus, causes the microcontroller to configure a current interrupt component to provide current flow from a voltage source to a device, responsive to detecting an over-current condition, set an over-current detected flag, and responsive to the over-current detected flag being set for a predetermined period of time, interrupt current flow to the device by opening the current interrupt component.

In one exemplary embodiment, the computer readable program further causes the microcontroller to responsive to an absence of the over-current condition for a recovery period, reset the over-current detected flag.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of a micro-controller control of direct current motors in which aspects of the illustrative embodiments may be implemented;

FIG. 2 is a diagram illustrating an exemplary micro-controller and current overload protection mechanism using a relay in accordance with an illustrative embodiment;

FIG. 3 is a diagram illustrating an exemplary micro-controller and current overload protection mechanism using a power field effect transistor in accordance with an illustrative embodiment;

FIG. 4 is a flowchart illustrating in-line control flow executed by the micro-controller at initial system power in accordance with an illustrative embodiment; and

FIG. 5 is a flowchart illustrating operation of the micro-controller for each timer interrupt in accordance with an illustrative embodiment.

### DETAILED DESCRIPTION OF THE ILLUSTRATIVE EMBODIMENTS

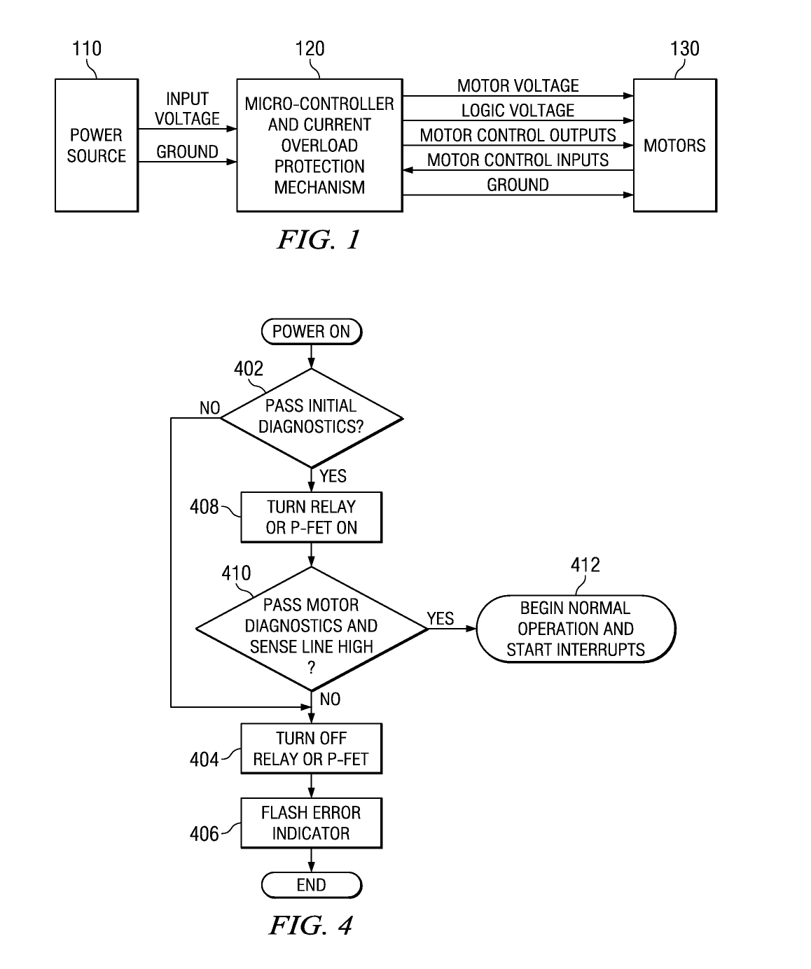

With reference now to the figures and in particular with reference to FIG. 1, an exemplary diagram of an environment is provided in which illustrative embodiments of the present invention may be implemented. It should be appreciated that FIG. 1 is only exemplary and is not intended to assert or imply any limitation with regard to the environments in which aspects or embodiments of the present invention may be implemented. Many modifications to the depicted environment may be made without departing from the spirit and scope of the present invention.

With reference now to the figures, FIG. 1 depicts a pictorial representation of a micro-controller control of direct current motors in which aspects of the illustrative embodiments may be implemented. Micro-controller and current overload protection mechanism 120 receives power from power source 110. The micro-controller and current overload protection mechanism 120 provides motor voltage, logic voltage, a ground potential, and motor control outputs to motors 130. Micro-controller and current overload protection mechanism 120 also receives motor control inputs from motors 130.

In accordance with the illustrative embodiments, micro-controller and current overload protection mechanism 120 senses and interrupts current flow used by motors 130. The mechanism 120 senses current through the use of a low value series sense resistor, as is common in the prior art. However, in the illustrative embodiments, the mechanism 120 performs the actual conversion of the voltage across the sense resistor to an over-current sense alarm signal with the use of an optical isolator, as will be described in further detail below. In response to an over-current sense alarm signal, mechanism 120 interrupts the primary power source using either a series relay or power field effect transistor (FET).

In one exemplary embodiment, micro-controller and current overload protection mechanism 120 may be incorporated into a device having at least one motor. For example, the device may be a printer or scanner having one or more motors where the micro-controller and current overload protection mechanism 120 senses and interrupts current flow used by motors 130. In another exemplary embodiment, micro-controller and current overload protection mechanism 120 may be a current control circuit that is external to the motors 130, or even external to the device.

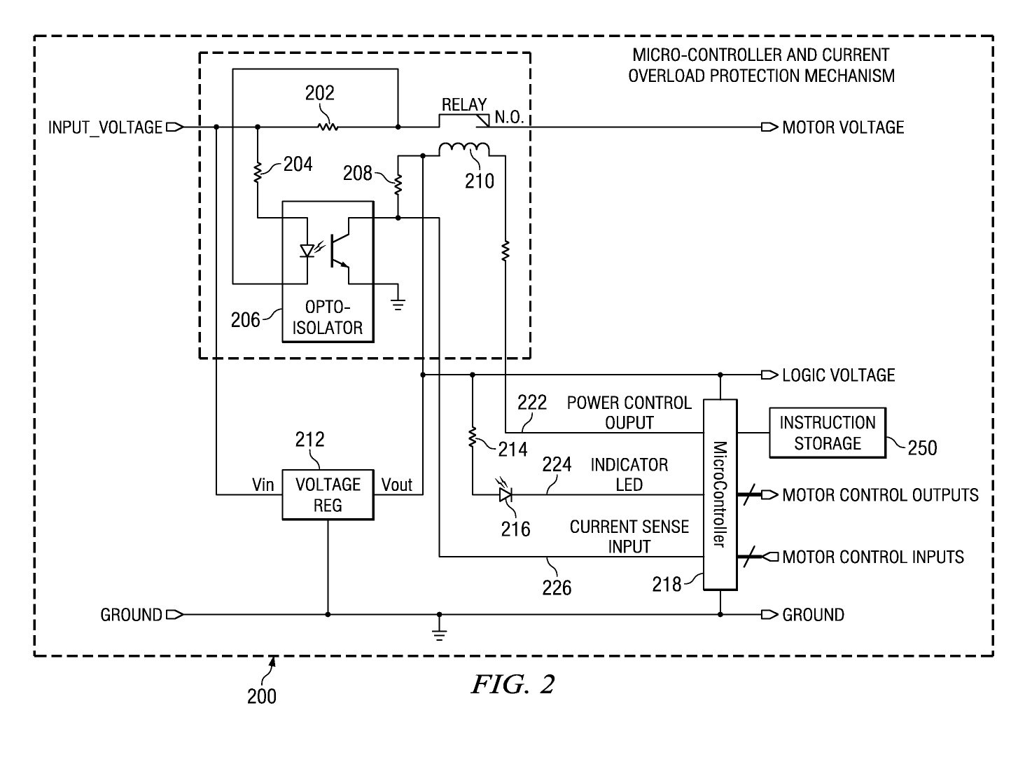

FIG. 2 is a diagram illustrating an exemplary micro-controller and current overload protection mechanism using a relay in accordance with an illustrative embodiment. In operation, micro-controller 218 and the remaining current control elements in mechanism 200 operate in concert as a “smart fuse.” This fuse mechanism performs the usual function of protecting the motor driver circuitry and the motors themselves against high current overload or short circuit conditions. The smart fuse “blows” any time the current levels reach a specified level for a specified period of time.

Micro-controller 218 operates under control of micro-controller code. This code may be personalized through the programming of the parameters for optimum operation in any particular application. Micro-controller 218 may receive instructions for the micro-controller code from instruction storage 250. Instruction storage 250 may be a volatile memory, such as dynamic random access memory, or a non-volatile memory, such as a read-only memory, flash memory, hard disk drive, or the like. Instruction storage 250 may also be implemented as an integrated memory element within micro-controller 218.

In normal operation, the input voltage (Input_Voltage) is within the expected limits, e.g., around 12V. Voltage regulator 212 receives the input voltage at Vin and outputs an operating voltage for the circuitry in mechanism 200. This voltage at Vout may be, for example, 5V. Micro-controller 218 holds power control output 222 low, which allows current to flow through relay 210.

Opto-isolator 206 comprises a light emitting diode (LED) and a phototransistor. When a sufficient amount of current flows through the LED of opto-isolator 206, the phototransistor “turns on,” allowing current to flow. When current flows through the switched circuit contacts of relay 210, this causes a voltage drop across resistor 202. Resistor 204 and the LED of opto-isolator 206 are in parallel with resistor 202; therefore, the voltage drop across resistor 202 is the same as the voltage drop across resistor 204 and the LED in opto-isolator 206. When this voltage is sufficient to turn on the LED of opto-isolator 206, the phototransistor of opto-isolator 206 begins to conduct and current then flows through resistor 208. This causes the voltage at current sense input 226 to go from high to low. Thus, micro-controller 218 senses an over-current condition at current sense input 226. The current sense input pin 226 of micro-controller 218 may be configured for Schmidt trigger operation to provide hysteresis for improved noise immunity.

In normal operation, micro-controller 218 holds power control output 222 low and indicator LED signal 224 high. In response to an over-current condition, as sensed at current sense input 226, micro-controller 218 may then deassert indicator LED signal 224, which causes current to flow through resistor 214 and indicator LED 216, thus turning on indicator LED 216. Thus, mechanism 200 may signal when the current drawn by the load has exceeded or is approaching a specified limit.

In response to an over-current condition existing for a predetermined period of time, micro-controller 218 asserts power control output 222 high, which results in current ceasing to flow through the coil of relay 210, thus interrupting power to the motors. In alternative embodiments, micro-controller 218 may activate indicator LED 216 when deactivating relay 210. Micro-controller 218 may also flash indicator LED 216 by intermittently asserting and deasserting indicator LED signal 224.

Sensing of the current (or power) load is performed using series, or “sense,” resistor 202. An over-current condition exists when the voltage drop across the sense resistor 202 exceeds a predetermined threshold. Optical isolator (opto-isolator) 206 is used as the sense control element, which sends a signal to micro-controller 218. With proper selection of series sensing resistor 202 and the optical isolator's current limiting resistor 204, the opto-isolator's internal LED is made to turn on once the current reaches the desired maximum threshold. At that point, the output phototransistor of opto-isolator 206 turns on and pulls the micro-controller's sense line low. To guard against false intermittent triggering whenever the current is near the limit, micro-controller 218 may configure the sense input line for Schmidt Trigger operation. Schmidt Triggers are generally well-known in the art.

Micro-controller 218 may monitor the state of sense line 226 in an interrupt service routine, for example. The interrupt service routine may be triggered by an internal timer. The timer value for triggering an internal periodic interrupt may be set from periods of less than a microsecond, for example, to as long as desired—usually in the millisecond to several seconds time range. Upon reaching the programmed timer count for a sensed over-current situation, micro-controller 218 may disable the current flow by de-energizing relay 210.

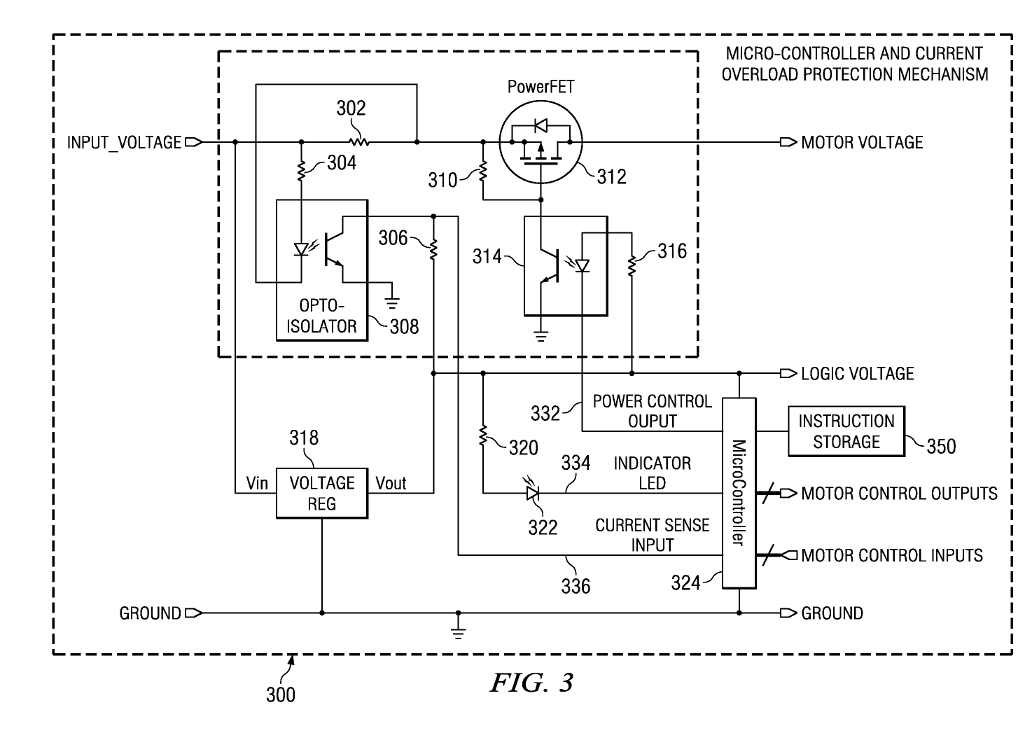

FIG. 3 is a diagram illustrating an exemplary micro-controller and current overload protection mechanism using a power field effect transistor in accordance with an illustrative embodiment. In operation, micro-controller 324 and the remaining current control elements in mechanism 300 operate in concert as a “smart fuse.” This fuse mechanism performs the usual function of protecting the motor driver circuitry and the motors themselves against high current overload or short circuit conditions. The smart fuse “blows” any time the current levels reach a specified level for a specified period of time.

Micro-controller 324 operates under control of micro-controller code. This code may be personalized through the programming of the parameters for optimum operation in any particular application. Micro-controller 324 may receive instructions for the micro-controller code from instruction storage 350. Instruction storage 350 may be a volatile memory, such as dynamic random access memory, or a non-volatile memory, such as a read-only memory, flash memory, hard disk drive, or the like. Instruction storage 350 may also be implemented as an integrated memory element within micro-controller 324.

In normal operation, the input voltage (Input_Voltage) is within the expected limits, e.g., around 12V. Voltage regulator 318 receives the input voltage at Vin and outputs an operating voltage for the circuitry in mechanism 300. This voltage at Vout may be, for example, 5V. Micro-controller 324 holds power control output 332 low, which allows current to flow through resistor 316 and the LED of opto-isolator 314. This causes the phototransistor of opto-isolator 314 to turn on, allowing current to also flow through resistor 302, resistor 310, and the phototransistor of opto-isolator 314. When current flows through the phototransistor of opto-isolator 314, this causes a voltage drop across resistor 302 and resistor 310. With this voltage drop, the voltage at the gate of power field effect transistor (FET) 312 becomes low, which “turns on” the power FET 312. When power FET 312 is “on,” current flows, providing voltage to the motors.

When current flows through power FET 312, this causes an additional, larger voltage drop across resistor 302. An over-current condition exists when the voltage drop across the sense resistor 302 exceeds a predetermined threshold. Resistor 304 and the LED of opto-isolator 308 are in parallel with resistor 302; therefore, the voltage drop across resistor 302 is the same as the voltage drop across resistor 304 and the LED in opto-isolator 308. When this voltage is sufficient to turn on the LED of opto-isolator 308, the phototransistor of opto-isolator 308 begins to conduct and current then flows through resistor 306. This causes the voltage at current sense input 336 to go from high to low. Thus, micro-controller 324 senses an over-current condition at current sense input 336.

In normal operation, micro-controller 324 holds power control output 332 low and indicator LED signal 334 high. In response to an over-current condition, as sensed at current sense input 336, micro-controller 324 may then deassert indicator LED signal 334, which causes current to flow through resistor 320 and indicator LED 322, thus turning on indicator LED 322. Thus, mechanism 300 may signal when the current drawn by the load has exceeded or is approaching a specified limit.

In response to an over-current condition existing for a predetermined period of time, micro-controller 324 asserts power control output 332 high, which results in current ceasing to flow through the LED of opto-isolator 314, which, in turn, results in current ceasing to flow through resistor 310. Thus, in this situation, the source and gate of power FET 312 are at the same voltage and power FET 312 is “turned off.” Opto-isolator 314 protects micro-controller 324 from the higher input voltage (Input_Voltage) at the gate of FET 312. The response time of power FET may be quicker than a mechanical relay, as in the example shown in FIG. 2.

In alternative embodiments, micro-controller 324 may activate indicator LED 322 when deactivating power FET 312. Micro-controller 324 may also flash indicator LED 322 by intermittently asserting and deasserting indicator LED signal 334.

Sensing of the current (or power) load is performed using series resistor 302. Optical isolator (opto-isolator) 308 is used as the sense control element, which sends a signal to micro-controller 324. With proper selection of series sensing resistor 302 and the optical isolator's current limiting resistor 304, the opto-isolator's internal LED is made to turn on once the current reaches the desired maximum threshold. At that point, the output phototransistor of opto-isolator 308 turns on and pulls the micro-controller's sense line low. To guard against false intermittent triggering whenever the current is near the limit, micro-controller 324 may configure the sense input line for Schmidt Trigger operation. Schmidt Triggers are generally well-known in the art.

Micro-controller 324 may monitor the state of sense line 336 in an interrupt service routine, for example. The interrupt service routine may be triggered by an internal timer. The timer value for triggering an internal periodic interrupt may be set from periods of less than a microsecond, for example, to as long as desired—usually in the millisecond to several seconds time range. Upon reaching the programmed timer count for a sensed over-current situation, micro-controller 324 may disable the current flow by disabling power FET 312.

FIG. 4 is a flowchart illustrating in-line control flow executed at initial system power in accordance with an illustrative embodiment. It will be understood that each block of the flowchart illustrations, and combinations of blocks in the flowchart illustrations, can be implemented by computer program instructions. These computer program instructions may be provided to a micro-controller or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a micro-controller or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems, which perform the specified functions or steps, or by combinations of special purpose hardware and computer instructions.

With reference now to FIG. 4, operation begins when power is supplied to the micro-controller and current overload protection mechanism. The micro-controller determines whether the mechanism passes initial diagnostics (block 402). If the mechanism does not pass initial diagnostics, the micro-controller turns off the relay or power FET (block 404) and flashes the error indicator (block 406). Thereafter, operation ends.

If the mechanism passes initial diagnostics in block 402, the micro-controller turns the relay or power FET on (block 408). Then, the micro-controller determines whether the motors pass motor diagnostics and the current sense line is high (inactive)(block 410). If the motors do not pass motor diagnostics or the current sense line is not high (indicating an over-current condition), the micro-controller turns off the relay or power FET (block 404) and flashes the error indicator (block 406). Thereafter, operation ends. If the motors pass motor diagnostics and the current sense line is high in block 410, the micro-controller begins normal operation and starts interrupts (block 412), and the initial power up operation phase ends.

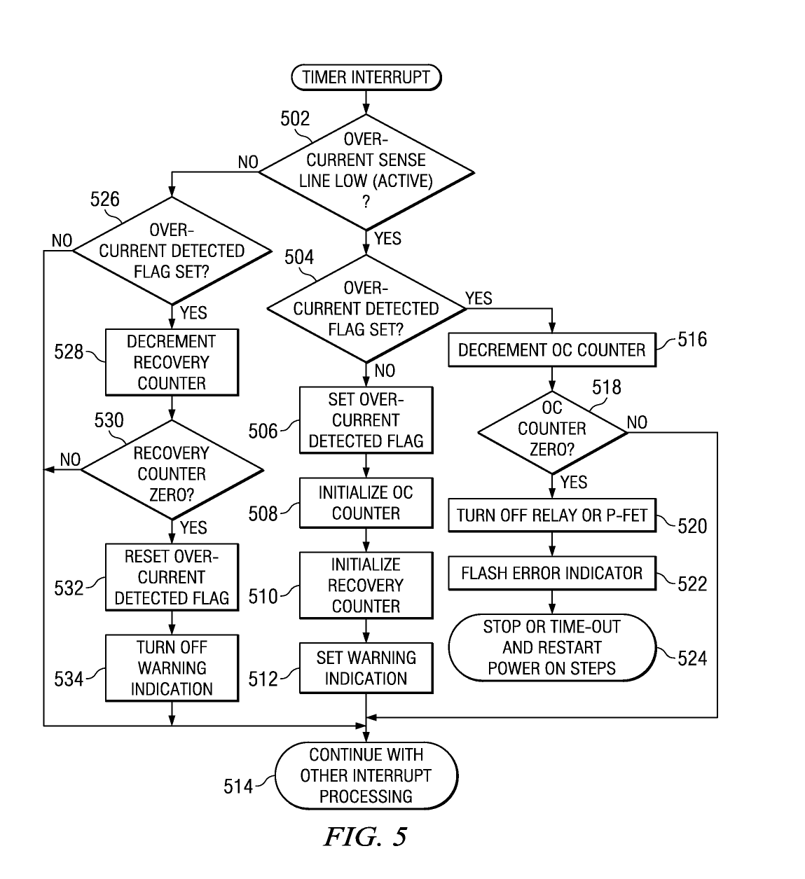

FIG. 5 is a flowchart illustrating operation of the micro-controller for each timer interrupt in accordance with an illustrative embodiment. Operation begins when a timer interrupt occurs in the micro-controller. The micro-controller determines whether the over-current sense line is low (active) (block 502). If the sense line is low, meaning there is an over-current condition, the micro-controller determines whether the over-current detected flag is set (block 504).

The over-current detected flag is a flag, e.g., a bit in a control register within the micro-controller, that the micro-controller uses to mark when an over-current condition first happens or ceases to happen. Thus, in block 504, if the over-current detected flag is not set, then the micro-controller determines that the over-current condition is a new over-current condition. In this case, the micro-controller sets the over-current detected flag (block 506) and initializes the over-current counter to a predetermined initial value (block 508).

In response to a new over-current condition, the micro-controller may set the over-current detected flag substantially immediately. As used herein, “substantially immediately” is a period of time that is the frequency of the interrupt timer. For instance, if the interrupt timer is set to generate an interrupt every microsecond, the operations of FIG. 5 occur every microsecond. Thus, the micro-controller may detect an over-current condition and set the over-current detected flag within a cycle of the interrupt time, which would appear to be immediate to a human observer. Then, the micro-controller initializes the recovery counter to a predetermined initial value (block 510). The micro-controller then sets a warning indication (block 512), and continues with other interrupt processing (block 514). Thereafter, this instance of over-current interrupt operation ends.

The micro-controller uses the over-current counter to determine the amount of time the protection mechanism is in an over-current condition. The micro-controller uses the recovery counter to time a recovery period after the over-current sense line goes inactive. Thus, the micro-controller and over-current protection mechanism may allow an over-current condition to exist up to a predetermined period of time, which is tuned by the interrupt timer and the initial value of the over-current counter, before turning off the relay or power FET. If the over-current sense line goes inactive after an over-current condition is detected, then the micro-controller waits for a recovery period to elapse before resetting the over-current detected flag. In other words, even if the over-current sense line temporarily goes inactive, the over-current protection mechanism remains in an over-current condition unless the over-current sense line remains inactive for the entire recovery period, which is tuned by the interrupt timer and the initial value of the over-current counter.

Returning to block 504, if the micro-controller determines that the over-current detected flag is set, meaning the over-current condition is pre-existing, the micro-controller decrements the over-current counter (block 516). Next, the micro-controller determines whether the over-current counter is equal to zero (block 518). If the over-current counter reaches zero, then the over-current condition has existed for a predetermined amount of time, which is tuned by the interrupt timer and the initial value of the over-current counter. If the over-current condition has not existed for the predetermined period of time, then the micro-controller continues with other interrupt processing (block 514), and this instance of over-current interrupt operation ends.

If, however, the over-current condition has existed for the predetermined period of time, the micro-controller turns off the relay or power FET (block 520) and flashes the error indicator (block 522). Thereafter, in block 524, the micro-controller stops operation or times out, and restarts the power-on steps described above with respect to FIG. 4.

Returning to block 502, if the over-current sense line is not low, meaning the sense line is inactive, the micro-controller determines whether the over-current detected flag is set (block 526). If the over-current detected flag is not set, then the protection mechanism is not in an over-current condition. In this case, the micro-controller continues with other interrupt processing (block 514), and operation ends.

If the over-current detected flag is set in block 526, then the protection mechanism is in an over-current condition even though the over-current sense line was found to be not active. The micro-controller decrements the recovery counter (block 528) and determines whether the recovery counter is equal to zero (block 530). If the recovery counter reaches zero, then the over-current sense line has been inactive for the entire recovery period, and the protection mechanism is no longer in an over-current condition. In this case, the micro-controller resets the over-current detected flag (block 532) and turns off the warning indication (block 534). Then, the micro-controller continues with other interrupt processing (block 514), and operation ends. If, however, the recovery counter is not equal to zero in block 530, then the micro-controller continues with other interrupt processing (block 514), and this instance of over-current interrupt operation ends.

The micro-controller or other circuit or logic implementing the operations illustrated in FIGS. 4 and 5 may exist within a housing of a motor. Alternatively, the micro-controller or other circuit or logic implementing the operations illustrated in FIGS. 4 and 5 may be external to the motor. The micro-controller or other circuit or logic implementing the operations illustrated in FIGS. 4 and 5 may alternatively be part of a device having one or more motors, such as a printer or scanner, for example.

Thus, the illustrative embodiments solve the disadvantages of the prior art by providing an over-current protection device that uses a micro-controller to sense and interrupt current flow used by motors. Because the same micro-controller that is operating the motors may be used for the overall application current monitoring, no significant hardware overhead is incurred. The micro-controller uses two input/output pins to perform the sensing and control.

In operation, current is sensed through the use of a low value series sense resistor as is common in the prior art. However, in the illustrative embodiments, the actual conversion of the voltage across the sense resistor to an over-current sense alarm signal is performed with the use of an optical isolator. In response to an over-current sense alarm signal, the micro-controller interrupts the primary power source using either a relay or power FET.

Because all operational parameters of the protection mechanism are under control of the micro-controller, they are easily modified to meet the needs of the specific motor control application. Furthermore, because of this flexibility of control, the mechanism may be used for other current-mode devices that may require short circuit protection while maintaining control over a wide dynamic range of operation. With no reliance on direct thermal sensing of the overload condition, response time can be as low as a microsecond, if required. Such response times are not possible with other methods commonly used in the prior art.

In addition, the use of the micro-controller allows real-time monitoring of any current surges in the application. If irregular spikes in current draw occur, they may be detected by the micro-controller and used to signal a near-over-current operating condition. This warning level of operation is not possible with fuses, circuit breakers, or resettable interrupters.

Micro-controller based relays have been used in switching alternating current circuits in industrial applications. However, those that are commercially available are generally rather large and meant as direct replacements for AC circuit breakers in rack configurations. These are dedicated circuit breakers. None of those commonly available lend themselves to applications where small physical size and printed circuit board mounting characteristics become important. In contrast, the micro-controller based over-current protection mechanism of the illustrative embodiments provides a device for detecting over-current conditions and interrupting current flow for smaller, direct current applications.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for protecting against current overload, comprising:
receiving, by a device, current flow from a voltage source;
responsive to detecting an over-current condition, setting an over-current detected flag; and
responsive to the over-current detected flag being set for a predetermined period of time, interrupting current flow to the device.

2. The method of claim 1, wherein the device comprises one of at least one motor or an external current control circuit coupled to a motor.

3. The method of claim 1, wherein the device performs the setting step and the interrupting step, and wherein the setting step occurs substantially immediately after the device detects an over-current condition.

4. The method of claim 1, further comprising:
in response to setting the over-current detected flag, decrementing a counter, wherein the counter fully decrements over the predetermined amount of time; and
while the counter is decrementing, selectively examining the over-current detected flag to determine whether the flag remains set.

5. The method of claim 1, further comprising:
sensing a voltage drop across a sense resistor wherein an over-current condition exists when the voltage drop across the sense resistor exceeds a predetermined threshold.

6. The method of claim 1, wherein sensing a voltage drop across a sense resistor comprises:
sensing whether an optical isolator that is connected in parallel with the sense resistor is in a closed state, wherein an over-current condition exists when the optical isolator is in a closed state.

7. The method of claim 1, wherein the interrupting step comprises opening a relay between the voltage source and the device.

8. The method of claim 7, further comprising:
responsive to detecting a non over-current condition when the over-current detected flag is set, performing the following steps:
waiting a second predetermined amount of time;
determining if the non over-current condition is present upon expiration of the second predetermined amount of time; and
responsive to determining that the non over-current condition is present, resetting the over-current detected flag.

9. The method of claim 1, wherein interrupting current flow to the device comprises:
providing a voltage to a source of a light emitting diode side of the optical isolator, wherein a phototransistor side of the optical isolator is connected to a gate of the power field effect transistor and is connected to a source of the power field effect transistor through a transistor; and
providing a voltage to a drain of the light emitting diode side of the optical isolator such that the light emitting diode side of the optical isolator does not emit light so that current does not flow through the phototransistor side of the optical isolator.

10. The method of claim 1, further comprising:
responsive to detecting an over-current condition, activating a warning light emitting diode.

11. The method of claim 1, further comprising:
responsive to an absence of the over-current condition for a recovery period, resetting the over-current detected flag.

12. A device, comprising:
at least one motor;
a series sense resistor and a current interrupt component in series between an input voltage and the at least one motor; and
a microcontroller, wherein the microcontroller, responsive to detecting an over-current condition at the series sense resistor, sets an over-current detected flag and responsive to the over-current detected flag being set for a predetermined period of time, interrupts current flow to the device using the current interrupt component.

13. The device of claim 12, wherein the micro-controller controls the at least one motor, and wherein the micro-controller performs the detecting, setting, and interrupting steps responsive to an interrupt timer.

14. A current overload protection apparatus, comprising:
a series sense resistor and a current interrupt component in series between an input voltage and a device; and
a microcontroller, wherein the microcontroller, responsive to detecting an over-current condition at the series sense resistor, sets an over-current detected flag and responsive to the over-current detected flag being set for a predetermined period of time, interrupts current flow to the device using the current interrupt component.

15. The current overload protection apparatus of claim 14, wherein the device comprises at least one motor.

16. The current overload protection apparatus of claim 14, further comprising:
an optical isolator connected in parallel with the sense resistor,
wherein the microcontroller senses whether the optical isolator is in a closed state, wherein an over-current condition exists when the optical isolator is in a closed state.

17. The current overload protection apparatus of claim 14, wherein the current interrupt component is a relay and wherein the microcontroller interrupts current to the device by opening the relay.

18. The current overload protection apparatus of claim 14, wherein the current interrupt component is a power field effect transistor, the current overload protection apparatus further comprising:
an optical isolator connected to the power field effect transistor,
wherein the microcontroller interrupts current to the device by opening the optical isolator such that the power field effect transistor changes to an open state.

19. A computer program product comprising a computer useable medium having a computer readable program, wherein the computer readable program, when executed on a microcontroller in a current overload protection apparatus, causes the microcontroller to:
configure a current interrupt component to provide current flow from a voltage source to a device;
responsive to detecting an over-current condition, set an over-current detected flag; and
responsive to the over-current detected flag being set for a predetermined period of time, interrupt current flow to the device by opening the current interrupt component.

20. The computer program product of claim 19, wherein the computer readable program further causes the microcontroller to:
responsive to an absence of the over-current condition for a recovery period, reset the over-current detected flag.
